(19) United States
(12) Patent Application Publication
(10) Pub. No.: US 2004/0197626 A1
(43) Pub. Date: Oct. 7, 2004

(54) Composite electrolyte for fuel cell

(76) Inventors: Yoocharn Jeon, Palo Alto, CA (US); Alfred I-Tsung Pan, Sunnyvale, CA (US); Ravi Prasad, Corvallis, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/405,654

(22) Filed: Apr. 1, 2003

(51) Int. Cl. H01M 8/10; B05D 5/12

(52) U.S. Cl. 429/30; 429/33; 427/115

(57) ABSTRACT

A structure useful as a composite electrolyte for a fuel cell includes a metal film, a polymeric electrolyte material, and at least one hydrophilic layer disposed between the metal film and the polymeric electrolyte material, thereby promoting adhesion of the polymeric electrolyte material to the metal film. Methods for making and using the composite electrolyte, a fuel cell, and electronic devices are disclosed.

### TECHNICAL FIELD

This invention relates to fuel cells and more particularly to fuel-cell structures including a composite electrolyte and related methods.

### BACKGROUND

Various portable devices, such as laptop computers, personal digital assistants (PDA's), portable digital and video cameras, portable music players, portable electronic games, and cellular phones or other wireless devices, require portable power sources. The weight and inconveniences of single-use batteries and rechargeable batteries have motivated efforts to replace those power sources for portable use. Thus, there is an increasing demand for light-weight, re-usable, efficient, and reliable power sources in such applications and in many other applications as well. In attempts to meet these needs, various portable fuel cells have been developed, such as ceramic-based solid-oxide fuel cells, direct methanol fuel-cell (DMFC) systems, reformed-methanol-to-hydrogen fuel-cell (RMHFC) systems, and other proton-exchange-membrane (PEM) fuel-cell systems. Microscale design principles have been applied to the design of portable fuel cells to provide improved power density and efficiency and to provide lower cost. There is a continuing need and a large anticipated market for improved practical compact portable fuel cells with rapid startup times and improved efficiency. There is a particular need for compact portable fuel cells with improved electrolyte portions. In DMFC fuel cells particularly, there is a need for fuel cells with reduced fuel crossover, i.e., un-reacted methanol passing through the electrolyte from the anode side to the cathode side.

### BRIEF DESCRIPTION OF THE DRAWINGS

The features and advantages of the disclosure will readily be appreciated by persons skilled in the art from the following detailed description when read in conjunction with the drawings, wherein:

FIG. 1 is an exploded perspective view of a first embodiment of a fuel cell incorporating an electrolyte made in accordance with the invention.

FIG. 2 is a side elevation cross-sectional view of the electrolyte embodiment of FIG. 1.

FIG. 3 is a side elevation cross-sectional view of a second embodiment of an electrolyte made in accordance with the invention.

FIG. 4 is a side elevation cross-sectional view of a third embodiment of an electrolyte made in accordance with the invention.

FIG. 5 is a side elevation cross-sectional view of a fourth embodiment of an electrolyte made in accordance with the invention.

FIG. 6 is a side elevation cross-sectional view of a fifth embodiment of an electrolyte made in accordance with the invention.

### DETAILED DESCRIPTION OF EMBODIMENTS

Throughout this specification and the appended claims, the term “fuel cell” means a fuel cell in its usual meaning or a battery cell having an anode, a cathode, and an electrolyte. The term “MEMS” has its conventional meaning of a micro-electro-mechanical system. The terms “anode reaction” and “cathode reaction,” referring to a fuel cell, mean the electrochemical reaction occurring at the anode or the cathode of the fuel cell respectively. (One example of an anode reaction is the conversion of methanol to carbon dioxide and hydrogen ions catalyzed by platinum at an anode, and one example of a cathode reaction is oxidation of protons to form water at a cathode.)

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting.

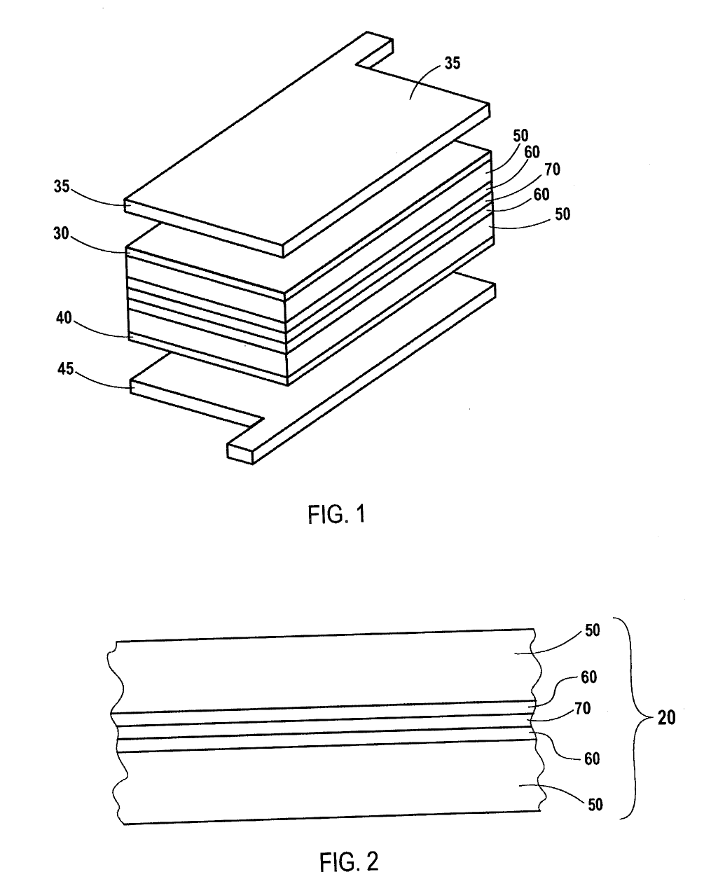

One aspect of the invention provides a fuel cell 10 incorporating a composite electrolyte 20, an anode 30, and a cathode 40. FIG. 1 shows an exploded perspective view, schematically illustrating a first embodiment of a fuel cell 10 incorporating a composite electrolyte 20 made in accordance with the invention. FIG. 2 shows a side elevation cross-sectional view of the electrolyte used in the embodiment of FIG. 1. As shown in the embodiment of FIGS. 1 and 2, composite electrolyte 20 may include a metal film 70 having two hydrophilic layers 60, one on each of its two sides, and two layers of polymeric electrolyte material 50, one on each side. Each of the hydrophilic layers 60 is adapted to provide adhesion between the metal film 70 and the layers of polymeric electrolyte material 50.

Fuel cell 10 may be a MEMS-based unit cell, forming one element of a stack of unit cells making up a fuel-cell assembly (not shown) that includes additional provisions such as conductive current-collecting electrodes, interconnections among the unit cells, and manifolding for fuel and oxidant supplies, for example. Composite electrolyte 20 includes a polymeric electrolyte material 50, at least one metal film 70, and at least one thin hydrophilic layer 60 between metal film 70 and the polymeric electrolyte material 50. Hydrophilic layer 60 provides enhanced adhesion between metal film 70 and the polymeric electrolyte material 50. While the embodiment shown in FIGS. 1 and 2 has two layers of polymeric electrolyte material 50, other embodiments described hereinbelow have one or more layers of polymeric electrolyte material 50. Similarly, various embodiments have various numbers of metal film layers and hydrophilic layers.

A hydrophilic layer is one which has a hydrophilic surface (typically characterized by wetting angle measured at a water drop on the surface). Wetting angle is generally measured from the solid surface on which the drop rests to a line that is tangent to the drop contour where it meets the solid surface. Wetting angles greater than 90° conventionally characterize a hydrophobic surface. Wetting angles less than 90° conventionally characterize a hydrophilic surface, such that smaller wetting angles correspond to more wetting, or more hydrophilic character.

The use of ion-conductive polymers such as a perfluorosulfonic acid resin proton-exchange membrane (e.g., Nafion™, commercially available from DuPont Fluoroproducts, a division of E.I. du Pont de Nemours and Company, Wilmington, Del.) in electrolytes of fuel cells is known in the art. Nafion™ resin is a perfluorosulfonic acid/PTFE copolymer in the acid (H⁺) form. Membranes of Nafion™ have high proton conductivity and good mechanical and chemical stability.

In direct methanol fuel cells, un-reacted methanol fuel can cross over, passing through the electrolyte from the anode side to the cathode side. One way of preventing such crossover is to use in or on the electrolyte a thin layer of a material that is permeable to protons but not to methanol, such as palladium metal. However, adhesion of metals to a stable, inert polymeric electrolyte material such as Nafion™ can be problematic, and swelling of polymeric electrolyte material near such a metal film can cause delamination.

A composite electrolyte 20 made in accordance with the invention can use an ion-conductive polymer such as a perfluorosulfonic acid resin proton-exchange membrane as the polymeric electrolyte material 50.

One skilled in the art will recognize that a variety of polymeric electrolyte materials may be exploited for use in embodiments of the invention. For example, depending on the application and the temperatures reached during fuel cell operation, polymeric electrolyte materials other than Nafion™ may be used. Other polymeric membrane electrolyte materials that may be used in various fuel-cell applications include partially sulfonated ethylene-styrene interpolymer (ESI), available from Dow Plastics, Midland, Mich.; sulfonated polyaryletherketone resin, available from Victrex USA of Greeneville, S.C.; and polybenzimidazole (PBI), available from Celanese Ventures GmbH, Frankfurt, Germany.

One skilled in the art will recognize that a variety of conductive materials may be used for anode 30 and cathode 40 in embodiments of the invention. For example, anode 30 or cathode 40 may be a suitable metal plate or thin film of a suitable metal catalyst, e.g., nickel, platinum, or platinum alloy. While anode 30 and cathode 40 are shown in FIG. 1 as continuous layers, platinum or platinum-alloy nanoparticle catalyst supported by carbon powder may be used as both electrodes (anode 30 and cathode 40), and conducting current-collectors 35 and 45 of graphite or stainless steel may be used to collect current from the electrodes. Current-collectors 35 and 45 may be formed as solid plates. If any of the electrodes (anode 30 and cathode 40) or current-collectors 35 and 45 are formed as thin films, they may be deposited by evaporation, sputtering, or any of a number of deposition methods known in the art for making MEMS structures or semiconductor integrated circuits.

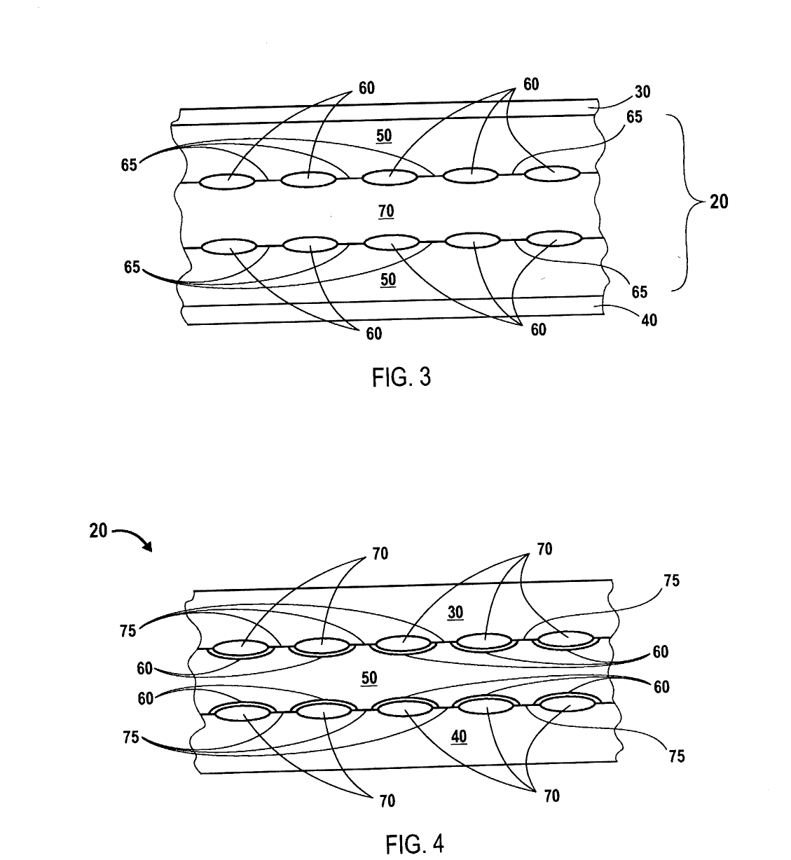

FIG. 3 is a side elevation cross-sectional view of a second embodiment of an electrolyte made in accordance with the invention, differing in some details from the first embodiment shown in FIGS. 1 and 2. The composite electrolyte 20 shown in FIG. 3 has a metal film 70 having hydrophilic layers 60 contiguous with both of its sides and layers of polymeric electrolyte material 50 contiguous with both hydrophilic layers at the top and bottom. In correspondence with FIG. 1, the top of FIG. 3 is the anode side of the electrolyte adjacent to anode 30 and the bottom of FIG. 2 is the cathode side adjacent to cathode 40. While FIG. 3 shows two hydrophilic layers 60 and two layers of polymeric electrolyte material 50, composite electrolyte 20 may also be made by omitting one of the layers of polymeric electrolyte material (at the cathode side for example). The corresponding hydrophilic layer 60 may also be omitted, i.e., the composite electrolyte may have a metal film 70 only at one side in such an embodiment.

The hydrophilic layers 60 may have openings 65 when used in applications for which hydrophilic layers 60 providing only partial coverage of metal film 70 have sufficient adhesion.

Metal film 70 may be a transition metal, such as platinum, palladium, tantalum, niobium, nickel, or alloys or mixtures of those metals. The metal of metal film 70 may be permeable to protons, but impermeable to the fuel used by the fuel cell (e.g., methanol). A metal film 70 on the anode side of composite electrolyte 20 may be a metal that acts as a catalyst for the anode reaction of the fuel cell. Similarly, a metal film 70 on the cathode side of composite electrolyte 20 may be a metal that acts as a catalyst for the cathode reaction of the fuel cell. If metal films 70 are present on both anode and cathode sides of the composite electrolyte, the compositions of the two metal films may be different. Another type of metal film 70 useful in some embodiments is a metal-carbon composite material.

Hydrophilic layer 60 is adapted to provide adhesion between polymeric electrolyte material 50 and metal film 70. Thus, hydrophilic layer 60 may be composed of a polymer having an acid group branch. Some suitable polymers are polysulfone, polyethersulfone, and cellulose, each being modified to have an acid group branch. The acid group branch may be a sulfonic acid group, for example. Methods of modifying such polymers to have such an acid group branch are known in the art. Generally, in order to provide the desired adhesion of metal film 70 to polymeric electrolyte material 50, hydrophilic layer 60 does not need to be a thick layer. Its thickness may be about ten micrometers or less, or even about one micrometer or less.

In most embodiments, the hydrophilic layer is adapted to adhere to both the metal film and the polymeric electrolyte material. However, in some embodiments, the hydrophilic layer may be adapted to adhere to the metal film while the polymeric electrolyte material is adapted to adhere to the hydrophilic layer.

FIG. 4 is a side elevation cross-sectional view of a third embodiment of an electrolyte made in accordance with the invention. As shown in the embodiment of FIG. 4, metal film 70 may be discontinuous in the sense of having small openings 75. Small openings 75 can allow additional proton current passing through metal film 70 (in addition to the proton diffusion that occurs even with a continuous metal film) while blocking larger fuel molecules, thus improving proton conductivity in the fuel cell. Small openings 75 may be made while depositing metal films 70 by stopping deposition and annealing before islands of deposited material fully cover the surface, or by depositing the metal at a slant angle across steps formed on the surface of polymeric electrolyte material 50. Very high resolution lithography, such as X-ray, electron-beam, or ion-beam lithography may be used to form extremely small openings 75 for allowing proton current but blocking very small fuel molecules such as methanol. Hydrophilic layer 60 is also discontinuous in FIG. 4, since it is present only at the interface between metal film 70 and polymeric electrolyte material 50. While FIG. 4 again shows composite electrolyte 20 with metal films 70 and hydrophilic layers 60 on both sides of polymeric electrolyte material 50, the metal film 70 on one side and the corresponding hydrophilic layer 60 may again be omitted (at the cathode side for example) if desired. It will be recognized that a continuous metal film 70 is generally more effective than a discontinuous film in preventing fuel crossover.

The composite electrolyte 20 shown in FIG. 4 has a polymeric electrolyte material 50 having hydrophilic layers 60 contiguous with both of its sides and metal films 70 contiguous with both hydrophilic layers at the top and bottom. In correspondence with FIGS. 1 and 3, the top of FIG. 4 may be the anode side of the electrolyte and the bottom of FIG. 4 may be the cathode side. While FIG. 4 shows two hydrophilic layers 60 and two metal films 70, composite electrolyte 20 may also be made by omitting one of the metal films (at the cathode side for example). The corresponding hydrophilic layer 60 may also be omitted, i.e., composite electrolyte may have a metal film 70 only at the anode side in such an embodiment.

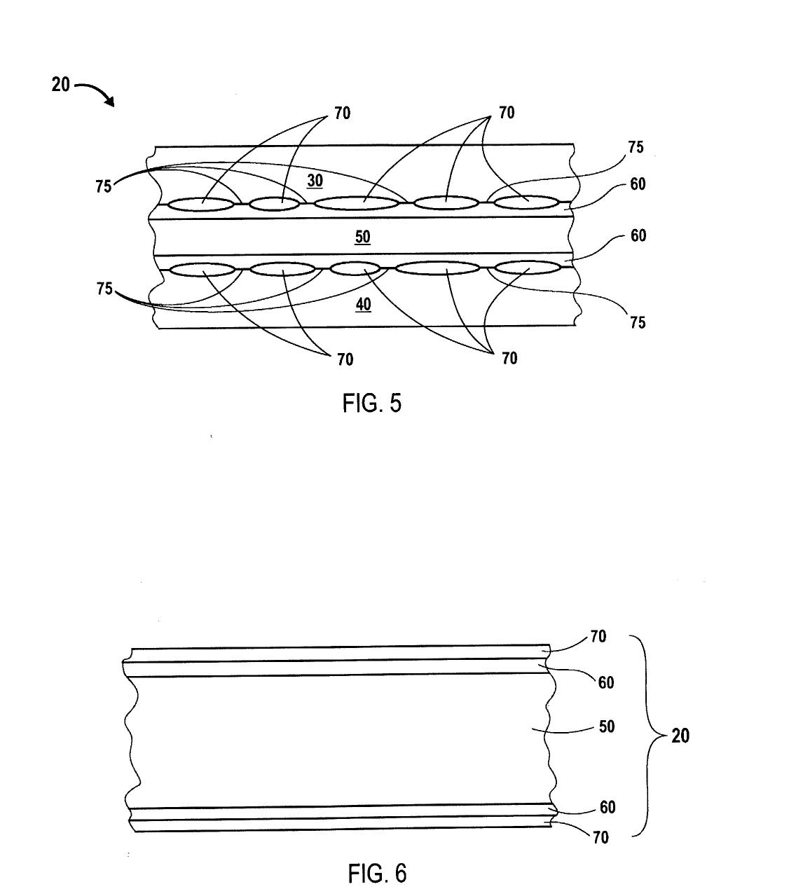

FIG. 5 is a side elevation cross-sectional view of a fourth embodiment of a composite electrolyte 20 made in accordance with the invention. Hydrophilic layer 60 is continuous in FIG. 5, extending both across the interface regions between metal film 70 and polymeric electrolyte material 50 and across the openings 75. Otherwise this embodiment is similar to that shown in FIG. 4. Although the openings 75 on opposite sides of polymeric electrolyte material 50 appear to be aligned in the drawings, they are not normally so aligned in actual practice and may be randomly situated relative to each other.

FIG. 6 is a side elevation cross-sectional view of a fifth embodiment of a composite electrolyte 20 made in accordance with the invention. The relatively simple embodiment of FIG. 6 has a single medial layer of polymeric electrolyte material 50 having continuous hydrophilic layers 60 contiguous with both of its sides and continuous metal films 70 contiguous with both hydrophilic layers 60 at the top and bottom. Again, in this embodiment, the hydrophilic layers 60 are adapted to adhere to both the metal films 70 and the polymeric electrolyte material 50. However, in similar embodiments, the hydrophilic layer may be adapted to adhere to the metal film while the polymeric electrolyte material is adapted to adhere to the hydrophilic layer.

Fabrication

Fabricating a composite fuel-cell electrolyte 20 in accordance with the invention is straightforward. The compositions of the various constituent materials are described hereinabove. Generally, a suitable metal film 70 is provided along with a quantity of polymeric electrolyte material 50. The polymeric electrolyte material 50 is affixed to the metal film 70, using a hydrophilic layer 60 disposed in contact with both the metal film 70 and the polymeric electrolyte material 50. For example, to fabricate the embodiment of FIG. 2, a quantity of polymeric electrolyte material 50 is cast or is cut from a pre-cast sheet or roll. A thin layer of polymeric hydrophilic layer 60 is applied onto one or both sides of polymeric electrolyte material 50 by casting from a solution, by tape-casting, or by spin-coating. For some applications, polymeric hydrophilic layer 60 may be applied by spraying. A thin metal film 70 is applied onto the hydrophilic layer 60 on one or both sides, e.g., by evaporation or sputtering from a metal source, by lamination transfer, by electroless plating or by electroplating. Formation of openings 75, if used, is described hereinabove. It will be recognized by those skilled in the art that similar steps may be followed to fabricate other embodiments, and that the order or sequence of operations may be varied accordingly.

Thus, an aspect of the invention is a method for fabricating an electrolyte for a fuel cell, including the steps of providing a metal film, providing a quantity of polymeric electrolyte material, and adhering the polymeric electrolyte material to the metal film with a hydrophilic layer disposed in contact with both the metal film and the polymeric electrolyte material.

Another aspect of the invention is a structure including a metal film, a polymeric electrolyte material, and at least one hydrophilic layer disposed between the metal film and the polymeric electrolyte material. Such a structure may be used in a fuel cell employing a composite electrolyte that includes a metal film, a polymeric electrolyte material, and at least one hydrophilic layer disposed between the metal film and the polymeric electrolyte material. The polymeric material for conducting ions is used in combination with both the metal film used for filtering the fuel and the hydrophilic layer for adhering the polymeric material to the metal film. The metal film can perform more than one function. It can filter fuel by preventing crossover of un-reacted fuel, i.e., preventing any unreacted fuel from passing through the electrolyte from the anode side to the cathode side. It can also filter fuel by preventing impurities and contaminants from passing through the electrolyte material. Besides filtering fuel, the metallic film may also serve for catalyzing the electrochemical reaction.

From another point of view, another aspect of the invention is a method for promoting adhesion between a noble metal and a hydrophobic polymer surface. A thin layer of a substantially hydrophilic substance is disposed between the noble metal and the hydrophobic polymer surface, and the substantially hydrophilic substance is affixed to both the noble metal and the hydrophobic polymer surface. As described above, the hydrophobic polymer surface may be a fluoropolymer surface such as a polymeric electrolyte material surface, specifically a perfluorosulfonic acid resin membrane such as Nafion™. One or both of the hydrophobic polymer and the substantially hydrophilic substance may be sulfonated.

From yet another point of view, the adhesion-promoting method described above provides a method of using a hydrophilic polymer material in a composite electrolyte for a fuel cell, by providing a metal film and a polymeric electrolyte material, by providing the hydrophilic polymer material, and by using a thin layer of the hydrophilic polymer material disposed between the metal film and the polymeric electrolyte material to affix the polymeric electrolyte material to the metal film, thus forming the composite electrolyte.

Industrial Applicability

A composite electrolyte made in accordance with the invention is useful in the manufacture of fuel cells. Fuel cells made by methods of the invention and electronic devices incorporating such fuel cells are applicable in many electrical and electronic applications, especially those requiring portable devices.

Although the foregoing has been a description and illustration of specific embodiments of the invention, various modifications and changes can be made thereto by persons skilled in the art without departing from the scope and spirit of the invention as defined by the following claims. For example, like the electrodes, the metal film used in various embodiments may be made in discontinuous form by using a layer of a suitable fine metal powder or a layer of fine particles of a suitable metal/carbon composite.

What is claimed is:

1. A structure comprising:
a metal film;
a polymeric electrolyte material; and
at least one hydrophilic layer disposed between the metal film and the polymeric electrolyte material.

2. An electrolyte for a fuel cell, the electrolyte comprising the structure as recited in claim 1.

3. An electrolyte for a fuel cell, the electrolyte comprising:
a metal film;
a polymeric electrolyte material; and
at least one hydrophilic layer disposed between the metal film and the polymeric electrolyte material.

4. A fuel cell comprising an anode, a cathode, and the electrolyte of claim 3.

5. An electronic device comprising the fuel cell of claim 4.

6. The electrolyte of claim 3, wherein the polymeric electrolyte material comprises an ion-conductive polymer.

7. The electrolyte of claim 3, wherein the polymeric electrolyte material comprises a proton-exchange membrane.

8. The electrolyte of claim 3, wherein the polymeric electrolyte material comprises a perfluorosulfonic acid resin membrane.

9. The electrolyte of claim 3, wherein the metal film comprises a metal permeable to protons.

10. The electrolyte of claim 3, wherein the fuel cell uses a fuel, and the metal film comprises a metal impermeable to the fuel.

11. The electrolyte of claim 10, wherein the fuel is methanol.

12. The electrolyte of claim 3, wherein the fuel cell uses a fuel, and the metal film comprises a metal both permeable to protons and impermeable to the fuel.

13. The electrolyte of claim 12, wherein the fuel is methanol.

14. The electrolyte of claim 3, wherein the fuel cell uses a fuel, and the metal film is adapted to prevent any unreacted fuel from passing through the electrolyte from the anode to the cathode of the fuel cell.

15. The electrolyte of claim 3, wherein the metal film is adapted to filter impurities and contaminants, whereby impurities and contaminants are prevented from passing through the electrolyte material.

16. The electrolyte of claim 3, wherein the fuel cell is characterized by an anode reaction and a cathode reaction, and the metal film comprises a catalyst for at least one of the anode reaction and the cathode reaction of the fuel cell.

17. The electrolyte of claim 3, wherein the metal film comprises a transition metal.

18. The electrolyte of claim 3, wherein the metal film comprises a metal-carbon composite material.

19. The electrolyte of claim 3, wherein the metal film comprises a metal selected from the group consisting of platinum, palladium, tantalum, niobium, nickel, and alloys and mixtures thereof.

20. The electrolyte of claim 3, wherein the metal film is discontinuous.

21. The electrolyte of claim 3, wherein said at least one hydrophilic layer is adapted to provide adhesion between the polymeric electrolyte material and the metal film.

22. The electrolyte of claim 3, wherein said at least one hydrophilic layer is characterized by a thickness of less than or about equal to 10 micrometers.

23. The electrolyte of claim 3, wherein said at least one hydrophilic layer is characterized by a thickness of less than or about equal to 1 micrometer.

24. The electrolyte of claim 3, wherein said at least one hydrophilic layer comprises a polymer having an acid group branch.

25. The electrolyte of claim 24, wherein said polymer having an acid group branch comprises a polymer selected from the group consisting of polysulfone, polyethersulfone, and cellulose, the selected polymer being modified to have an acid group branch.

26. The electrolyte of claim 24, wherein said acid group branch comprises a sulfonic acid group.

27. A method for promoting adhesion between a noble metal and a hydrophobic polymer surface, the method comprising the steps of:
a) disposing a thin layer of a substantially hydrophilic substance between the noble metal and the hydrophobic polymer surface; and
b) affixing the substantially hydrophilic substance to both the noble metal and the hydrophobic polymer surface.

28. The method of claim 27, wherein the hydrophobic polymer surface is a fluoropolymer surface.

29. The method of claim 27, wherein at least one of the hydrophobic polymer and the substantially hydrophilic substance is sulfonated.

30. The method of claim 27, wherein the hydrophobic polymer surface is a polymeric electrolyte material surface.

31. The method of claim 30, wherein the polymeric electrolyte material comprises a perfluorosulfonic acid resin membrane.

32. The method of claim 29, wherein the noble metal, the substantially hydrophilic substance, and the polymeric electrolyte material, combined together, form a composite electrolyte for a fuel cell.

33. A composite electrolyte for a fuel cell, made by the method of claim 29.

34. A composite electrolyte for a fuel cell, made by the method of claim 27.

35. A fuel cell comprising the composite electrolyte of claim 34.

36. An electronic device comprising the fuel cell of claim 36.

37. An electrolyte for a fuel cell, the electrolyte comprising:
a polymeric electrolyte material having first and second sides;
a first hydrophilic layer contiguous with the first side of the polymeric electrolyte material;
a first metal film contiguous with the first hydrophilic layer;
a second hydrophilic layer contiguous with the second side of the polymeric electrolyte material; and
a second metal film contiguous with the second hydrophilic layer.

38. A fuel cell comprising an anode, a cathode, and the electrolyte of claim 37.

39. An electronic device comprising the fuel cell of claim 38.

40. The electrolyte of claim 37, wherein the first and second metal films comprise a metal selected from the group consisting of platinum, palladium, tantalum, niobium, nickel, and alloys and mixtures thereof.

41. The electrolyte of claim 37, wherein the polymeric electrolyte material comprises an ion-conductive polymer.

42. The electrolyte of claim 37, wherein the polymeric electrolyte material comprises a perfluorosulfonic acid resin membrane.

43. The electrolyte of claim 37, wherein each of the first hydrophilic layer and the first metal film is discontinuous.

44. The electrolyte of claim 37, wherein each of the second hydrophilic layer and the second metal film is discontinuous.

45. The electrolyte of claim 37, wherein the first hydrophilic layer is adapted to provide adhesion between the polymeric electrolyte material and the first metal film.

46. The electrolyte of claim 37, wherein the first hydrophilic layer is characterized by a thickness of less than or about equal to 10 micrometers.

47. The electrolyte of claim 37, wherein the first hydrophilic layer is characterized by a thickness of less than or about equal to 1 micrometer.

48. The electrolyte of claim 37, wherein said first hydrophilic layer comprises a polymer having an acid group branch.

49. The electrolyte of claim 48, wherein said polymer having an acid group branch comprises a polymer selected from the group consisting of polysulfone, polyethersulfone, and cellulose, the selected polymer being modified to have an acid group branch.

50. The electrolyte of claim 48, wherein said acid group branch comprises a sulfonic acid group.

51. The electrolyte of claim 37, wherein the second hydrophilic layer is adapted to provide adhesion between the polymeric electrolyte material and the second metal film.

52. The electrolyte of claim 37, wherein the second hydrophilic layer is characterized by a thickness of less than or about equal to 10 micrometers.

53. The electrolyte of claim 37, wherein the second hydrophilic layer is characterized by a thickness of less than or about equal to 1 micrometer.

54. The electrolyte of claim 37, wherein said second hydrophilic layer comprises a polymer having an acid group branch.

55. The electrolyte of claim 54, wherein said polymer having an acid group branch comprises a polymer selected from the group consisting of polysulfone, polyethersulfone, and cellulose, the selected polymer being modified to have an acid group branch.

56. The electrolyte of claim 54, wherein said acid group branch comprises a sulfonic acid group.

57. An electrolyte for a fuel cell, the electrolyte comprising:
a metal film having first and second sides;
a first hydrophilic layer contiguous with the first side of the metal film;
a first polymeric electrolyte material layer contiguous with the first hydrophilic layer;
a second hydrophilic layer contiguous with the second side of the metal film; and
a second polymeric electrolyte material layer contiguous with the second hydrophilic layer,
each of the first and second hydrophilic layers being adapted to provide adhesion between the metal film and the first and second polymeric electrolyte material layers respectively.

58. A fuel cell comprising an anode, a cathode, and the electrolyte of claim 57.

59. An electronic device comprising the fuel cell of claim 58.

60. An electrolyte for a fuel cell, the electrolyte comprising:
a metal film having first and second sides;
a first hydrophilic layer contiguous with the first side of the metal film;
a first polymeric electrolyte material layer contiguous with the first hydrophilic layer;
a second hydrophilic layer contiguous with the second side of the metal film; and
a second polymeric electrolyte material layer contiguous with the second hydrophilic layer, each of the first and second polymeric electrolyte material layers comprising an ion-conductive polymer, and each of the first and second hydrophilic layers comprising a polymer having an acid group branch, whereby the first and second hydrophilic layers provide adhesion between the metal film and the first and second polymeric electrolyte material layers respectively.

61. The electrolyte of claim 60, wherein the metal film comprises a metal selected from the group consisting of platinum, palladium, tantalum, niobium, nickel, and alloys and mixtures thereof.

62. The electrolyte of claim 60, wherein the metal film is discontinuous.

63. The electrolyte of claim 60, wherein each of the first and second polymeric electrolyte material layers comprises a perfluorosulfonic acid resin membrane.

64. The electrolyte of claim 60, wherein said polymer having an acid group branch comprises a polymer selected from the group consisting of polysulfone, polyethersulfone, and cellulose, the selected polymer being modified to have an acid group branch.

65. A fuel cell comprising an anode, a cathode, and the electrolyte of claim 60.

66. An electronic device comprising the fuel cell of claim 65.

67. An electrolyte for a fuel cell using a fuel, the electrolyte comprising in combination:
polymeric means for conducting ions;
metallic means for filtering the fuel; and
at least one means for adhering the polymeric means for conducting to the metallic means for filtering fuel, the means for adhering being hydrophilic, and the means for adhering being disposed between the polymeric means for conducting and the metallic means for filtering fuel.

68. The electrolyte of claim 67, wherein the metallic means for filtering fuel comprises means for catalyzing an electrochemical reaction.

69. A fuel cell comprising an anode, a cathode, and the electrolyte of claim 67.

70. An electronic device comprising the fuel cell of claim 69.

71. A method for fabricating an electrolyte for a fuel cell, said method comprising the steps of:
providing a metal film;
providing a quantity of polymeric electrolyte material; and
adhering the polymeric electrolyte material to the metal film with a hydrophilic layer disposed in contact with both the metal film and the polymeric electrolyte material.

72. A method for fabricating a composite electrolyte for a fuel cell, said method comprising the steps of:
providing a metal film;
providing a quantity of polymeric electrolyte material;
coating at least a portion of the metal film with a hydrophilic layer; and
disposing the polymeric electrolyte material in contact with the hydrophilic layer, whereby at least a portion of the hydrophilic layer is disposed between the metal film and the polymeric electrolyte material.

73. A composite electrolyte made by the method of claim 72.

74. A fuel cell comprising an anode, a cathode, and the composite electrolyte made by the method of claim 72.

75. An electronic device comprising the fuel cell of claim 74.

76. The method of claim 72, wherein the hydrophilic layer is adapted to adhere to the metal film and the polymeric electrolyte material is adapted to adhere to the hydrophilic layer.

77. The method of claim 72, wherein the hydrophilic layer is adapted to adhere to the metal film and the hydrophilic layer is adapted to adhere to the polymeric electrolyte material.

78. The method of claim 72, wherein the polymeric electrolyte material comprises a proton-exchange membrane.

79. The method of claim 72, wherein the polymeric electrolyte material comprises a perfluorosulfonic acid resin membrane.

80. The method of claim 72, wherein the metal film comprises a metal selected from the group consisting of platinum, palladium, tantalum, niobium, nickel, and alloys and mixtures thereof.

81. The method of claim 72, wherein the hydrophilic layer comprises a polymer selected from the group consisting of polysulfone, polyethersulfone, and cellulose, the selected polymer being modified to have an acid group branch.

82. A method of using a hydrophilic polymer material in a composite electrolyte for a fuel cell, said method comprising the steps of:
providing a metal film and a polymeric electrolyte material;
providing the hydrophilic polymer material; and
using a thin layer of the hydrophilic polymer material disposed between the metal film and the polymeric electrolyte material to affix the polymeric electrolyte material to the metal film, thus forming the composite electrolyte.
